(19) United States
(12) Patent Application Publication
(10) Pub. No.: US 2009/0042535 A1
(43) Pub. Date: Feb. 12, 2009

(54) METERING DATA REPORT METHOD FOR DRM SYSTEM

(75) Inventor: Yong Seock CHOI, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/177,735

(22) Filed: Jul. 22, 2008

(30) Foreign Application Priority Data
Aug. 8, 2007 (KR) 2007-79511

(51) Int. Cl. H04M 11/00; H04L 12/58

(52) U.S. Cl. 455/405; 455/412.1

(57) ABSTRACT

A metering data report method and apparatus of a Digital Right Management (DRM) enabled mobile terminal is provided for improving stability and reliability of metering data report. An information provision method and apparatus of the invention determines whether an amount of metering data accumulated is greater than a threshold amount and transmits, when the metering data amount is greater than the threshold amount, the metering data to a Rights Issuer (RI).

### PRIORITY

This application claims the benefit under 35 U.S.C. § 119(a) of a Korean patent application filed in the Korean Intellectual Property Office on Aug. 8, 2007 and assigned Serial No. 2007-0079511, the entire disclosure of which is hereby incorporated by reference.

### BACKGROUND OF THE INVENTION

1. Field of the Invention The present invention relates to a Digital Right Management (DRM) system for use with mobile terminals. More particularly, the present invention relates to an improved metering data report method and apparatus of a DRM-enabled mobile terminal.

2. Description of the Related Art

Currently, with the rapid development of a mobile content business and the rapid growth of mobile devices, various digital content (such as ring tones, background images, music files, Java applications, and the like) are distributed over mobile communication networks. In early mobile content business, copy protection was not considered significantly since early mobile devices were implemented to support only downloading and not sharing the content with other devices.

As the content download services have grown in popularity and the mobile devices have evolved to be able to exchange data with each other, mobile content providers are becoming interested in copy protection technologies.

Various Digital Rights Management (DRM) technologies were already used for preventing illegal distribution of copyright protected digital content on the wired Internet, and the mobile content providers have strived to adopt the DRM technologies to the mobile communication networks effectively, whereby the DRM technologies have been standardized into a single technology, i.e. Open Mobile Alliance (OMA) DRM.

According to the current OMA DRM standard, a mobile device that downloads a DRM content provides a metering report to the Right Issuer (RI) in response to a metering report request. However, such a conventional metering data report method does not guarantee a stable provision of the metering data.

Therefore, a need exists for an improved metering data report method and apparatus enabling a DRM in a mobile terminal.

### SUMMARY OF THE INVENTION

An aspect of the present invention is to address the above-mentioned problems and/or disadvantages and to provide at least the advantages described below. Accordingly, an aspect of the present invention is to provide a metering data report method and apparatus for a Digital Right Management (DRM) enabled mobile terminal that is capable of providing a metering report stably and improving reliability of the metering report.

In accordance with an aspect of the present invention, an information provision method for a mobile terminal is provided. The method includes determining whether an amount of metering data accumulated is greater than a threshold amount, and transmitting, when the metering data amount is greater than the threshold amount, the metering data.

In accordance with another aspect of the present invention, an information provision method for a mobile terminal is provided. The method includes receiving a trigger message requesting a metering report, and transmitting, in response to the trigger message, a submit message containing a parameter indicating whether a metering report is available.

In accordance with still another aspect of the present invention, an information provision apparatus of a mobile terminal is provided. The apparatus includes a radio frequency unit for transmitting and receiving control messages, and a control unit for determining whether to transmit a metering report according to a state of the mobile terminal and for transmitting, when the state of the mobile terminal is available for transmitting a metering report, the metering report to a Right Issuer (RI).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a Digital Right Management (DRM) system operating with a metering data report method according to an exemplary embodiment of the present invention;

FIG. 2 is a block diagram illustrating a configuration of a mobile terminal according to an exemplary embodiment of the present invention;

FIG. 3 is a message flow diagram illustrating a metering data report method according to an exemplary embodiment of the present invention;

FIG. 4 is a message flow diagram illustrating a metering data report method according to an exemplary embodiment of the present invention; and

FIG. 5 is a message flow diagram illustrating a metering data report method according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Although the metering data report method is described in association with a mobile terminal in the following description, the present invention is not limited thereto. For example, the metering data report method and apparatus of the present invention can be implemented with various types of portable devices such as a Code Division Multiple Access (CDMA) terminal, a digital broadcast receiver, a Personal Digital Assistant (PDA), a Smartphone, a 3^{rd} Generation (3G) terminal including a Wideband CDMA (WCDMA) terminal and a CDMA2000 terminal, a Global System for mobile Communication (GSM) terminal, a General Packet Radio Service (GPRS) terminal, and their equivalents.

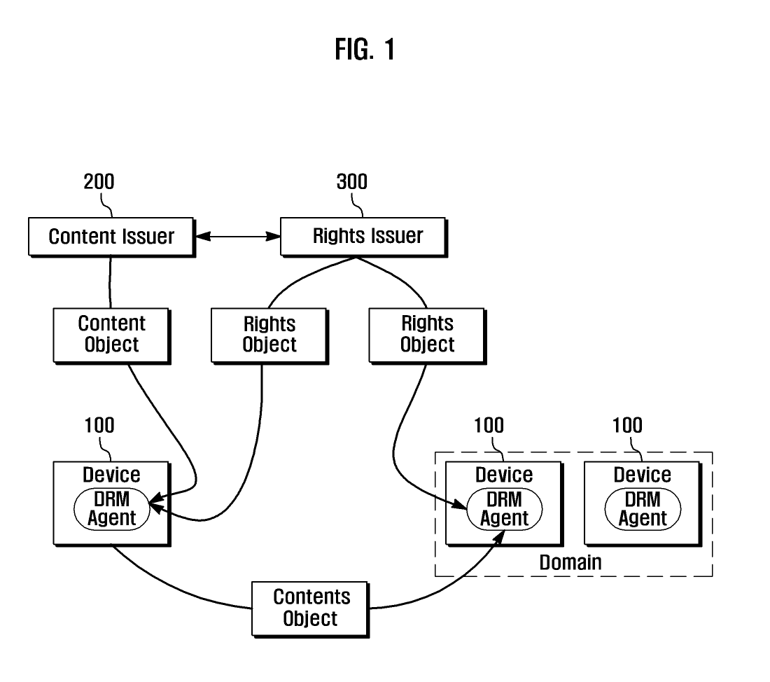

FIG. 1 is a block diagram illustrating a DRM system operating with a metering data report method according to an exemplary embodiment of the present invention.

Referring to FIG. 1, the DRM system includes a plurality of devices 100, a Content Issuer (CI) 200, and a Right Issuer (RI) 300.

Each device 100 includes a DRM agent for performing a DRM function and the DRM agent can be implemented in the form of software, hardware, or a combination of software and hardware. The device 100 can be part of a mobile terminal.

The device 100 may acquire a Content Object (CO) and a Right Object (RO) from the CI 200 and the RI 300 and may exchange the CO and RO with another device through a mobile communication network. In order for the device 100 to acquire the CO and RO from another device, the devices should belong to the same domain. In order to enter a domain, the device 100 should pass an authentication and register with the domain.

In an exemplary embodiment, the device 100 is configured to directly acquire the CO and RO from the network. The device 100 is configured to support a metering service.

The CI 200 issues DRM contents, i.e. COs, to the devices 100. Although it is depicted in FIG. 1 that the CI 200 sends a CO to a single device 100, the CI 200 can send a CO to multiple devices 100 simultaneously.

The RI 300 issues ROs to the devices 100. The RI 300 supports the metering service.

A CO downloaded from the CI 200 may be used with a corresponding RO issued by the RI 300. The CO may be transmitted or copied to another device. However, in order to use the copied CO, it may be required to acquire an RO from the RI 300.

In the following, the metering data report method of an exemplary embodiment of the present invention is described in association with a mobile terminal as the device. However, the device is not limited to a mobile terminal, but can be any of various types of electronic devices having a DRM agent and supporting communications with the CI and RI through a network.

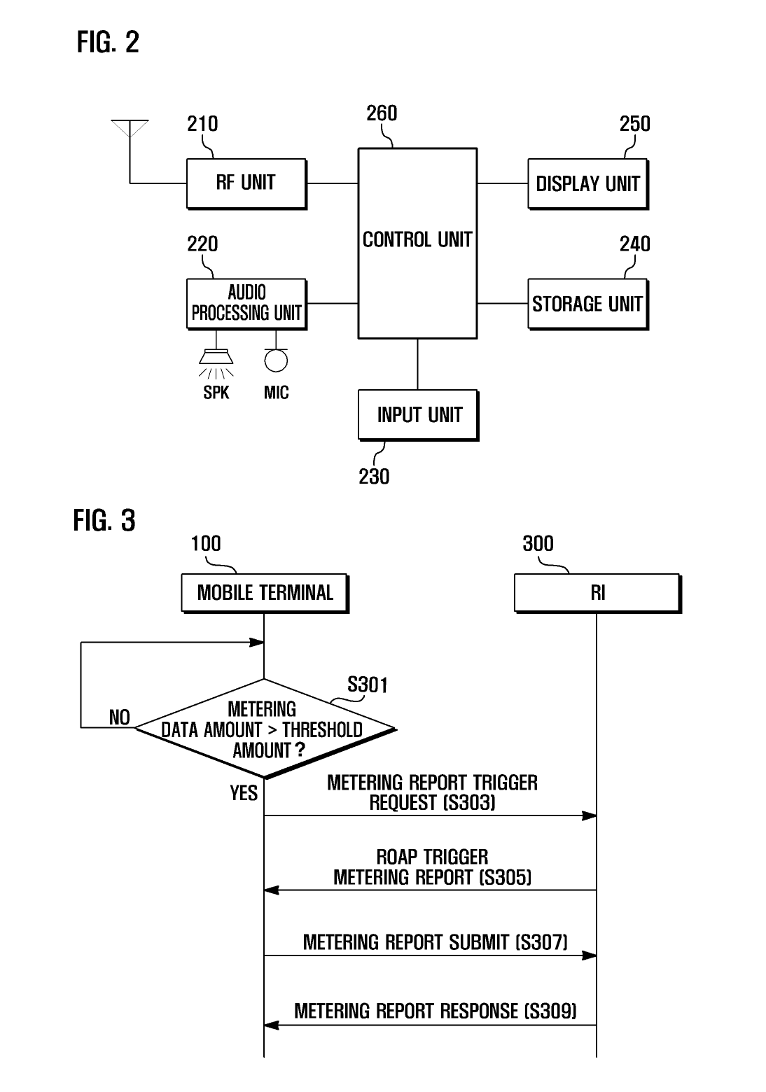

FIG. 2 is a block diagram illustrating a configuration of a mobile terminal according to an exemplary embodiment of the present invention.

Referring to FIG. 2, the mobile terminal includes a Radio Frequency (RF) unit 210, an audio processing unit 220, an input unit 230, a storage unit 240, a display unit 250, and a control unit 260.

The RF unit 210 is responsible for radio communications of the mobile terminal with a wireless communication network. The RF unit 210 converts a baseband signal received from the control unit 260 into an Intermediate Frequency (IF) signal and then a Radio Frequency (RF) signal to transmit the signal through an antenna (ANT). The RF unit 210 also converts a Radio Frequency (RF) signal received through the antenna (ANT) into an Intermediate Frequency (IF) signal and then into a baseband signal to send the signal to the control unit 260.

The audio processing unit 220 processes an audio data supplied by the control unit 260 to output the processed audio data through a speaker (SPK) in a form of an audible sound wave and processes the audio signal including voice input through a microphone (MIC) to supply the processed audio signal to the control unit 260.

The input unit 230 is provided with a plurality of alphanumeric keys for receiving alphanumeric data inputs and a plurality of function keys for executing various functions of the mobile terminal. The input unit 230 generates key signals in response to user's key inputs and transmits the key input signals to the control unit 260.

The storage unit 240 may be implemented with at least one of a Random Access Memory (RAM), a Read Only Memory (ROM), and an Erasable Programmable Read Only Memory (EPROM). The storage unit 240 may be divided into a program region and a data region. The program region stores an Operating System (OS) for booting the mobile terminal and application programs for performing functions of the mobile terminal. The data region stores metering data to be reported to the RI.

The display unit 250 provides the user with various information visually. The display unit 250 may be implemented with a Liquid Crystal Display (LCD). More particularly, when the LCD supports touchscreen functions, the display unit 250 may act as a part of the input unit 230.

The control unit 260 controls general operations of the mobile terminal and signaling among internal elements of the mobile terminal. That is, the control unit 260 controls cooperative signaling among the RF unit 210, the audio processing unit 220, the input unit 230, the storage unit 240, the display unit 250 and the like.

The control unit 260 controls to execute functions in response to user inputs (e.g., key signals on a keypad and touch signals on a touchscreen) and displays the execution results and function menus on a screen of the display unit 250.

In an exemplary implementation, the control unit 260 may be configured to support at least one of a Hyperlink Text Transfer Protocol (HTTP), an OMA Download Over-The-Air (OMA Download OTA), a Download OTA, and a Wireless Application Protocol (WAP) Push. That is, the control unit 260 controls the metering data to be transmitted by means of the RF unit 210 using one of the above protocols. The control unit 260 includes a modem (not shown) and a codec (not shown). In an exemplary configuration, the control unit 260 further includes a DRM agent module (not shown) compliant with an OMA DRM specification.

Although not shown in FIG. 2, the mobile terminal is provided with at least one of a memory slot for receiving an external storage media such as a memory card, a data connection port for exchanging data with an external device, and a power charging port. Also, the mobile terminal may include at least one of a broadcast receiver module for receipt of a digital broadcast signal, a camera module, a music player module such as an MP3 module and the like. Although all the possible modules are not enumerated, it is obvious to those skilled in the art that various application modules can be converged with the mobile terminal.

A metering data report method of the above structured mobile terminal is described hereinafter.

FIG. 3 is a message flow diagram illustrating a metering data report method according to an exemplary embodiment of the present invention.

In an exemplary embodiment, a preset amount of memory space is allocated for storing metering data with a threshold. For example, 5 Mbyte memory space is allocated for the metering data with a threshold amount of 4.5 Mbyte.

Referring to FIG. 3, the mobile terminal 100 monitors the storage unit 240 to determine whether the amount of metering data is greater than the threshold amount in step S301. If the metering data amount is greater than the threshold amount, the mobile terminal 100 transmits a Metering Report Trigger Request message to the RI 300 in step S303. The Metering Report Trigger Request message is a message for requesting the RI 300 to transmit the Metering Report Trigger message.

Upon receipt of the Metering Report Trigger Request message, the RI 300 transmits a Rights Object Acquisition Protocol (ROAP) Trigger Metering Report message to the mobile terminal 100 in step S305.

If the ROAP Trigger Metering Report message is received, the mobile terminal 100 transmits a Metering Report Submit message containing the metering data to the RI 300 in step S307.

Upon receipt of the Metering Report Submit message, the RI 300 transmits a Metering Report Response message to the mobile terminal 100 in step S309.

As described above, since the mobile terminal 100 requests the RI for a trigger metering report message when the metering data amount exceeds the threshold amount, it is possible to prevent the metering data from being lost by overwriting.

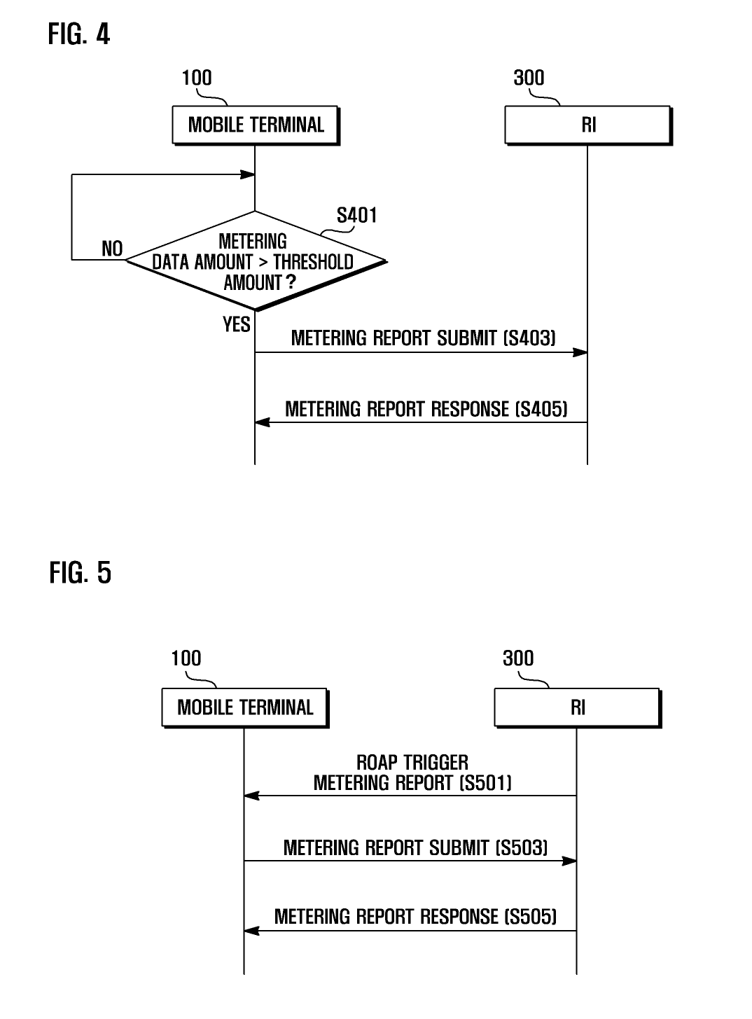

FIG. 4 is a message flow diagram illustrating a metering data report method according to an exemplary embodiment of the present invention. As in an exemplary embodiment of FIG. 3, a preset amount of memory space is allocated for storing the metering data with a threshold. For example, 5 Mbyte memory space is allocated for the metering data with a threshold amount of 4.5 Mbyte.

Referring to FIG. 4, the mobile terminal 100 monitors the storage unit 240 to determine whether the metering data amount is greater than the threshold amount in step S401.

If the metering data amount is greater than the threshold amount, the mobile terminal 100 transmits a Metering Report Submit message to the RI 300 in step S403. The Metering Report Submit message contains the metering data. The Metering Report Submit message also contains information for indicating that the metering data amount exceeds the threshold amount.

Table 1 shows parameters carried by the Metering Report Submit message.

TABLE 1

| Parameter | Mandatory/Optional |
|---|---|
| Device ID | M |
| RI ID | M |
| Device Nonce | M |
| Report Time | M |
| Metering Report | M |
| Certificate Chain | O |
| Extensions | O |
| Signature | M |

As shown in table 1, the Metering Report Submit message contains parameters such as a Device ID, an RI ID, a Device Nonce, a Report Time, a Metering Report, a Certificate Chain, Extensions, and a Signature.

Here, the parameter “Extensions” indicates that the metering data amount accumulated in the mobile terminal 100 exceeds the threshold amount. Referring to the parameter “Extensions”, the RI recognizes that the mobile terminal transmits the metering data for preventing the metering data from being overwritten.

In response to the Metering Report Submit message, the RI 300 transmits a Metering Report Response message to the mobile terminal in step S405.

As described above, when detecting that the metering data amount exceeds the preset threshold amount, the mobile terminal 100 transmits the Metering Report Submit message containing the metering data to the RI 300 regardless of receipt of the Metering Report Trigger message, thereby protecting metering data loss caused by overwriting.

FIG. 5 is a message flow diagram illustrating a metering data report method according to an exemplary embodiment of the present invention.

Referring to FIG. 5, the mobile terminal 100 first receives an ROAP Trigger Metering Report message transmitted by the RI 300 in step S501. The ROAP Trigger Metering Report message is a message for requesting the mobile terminal 100 to provide the metering report.

Here, it is assumed that the mobile terminal 100 is not stable for securely replying in response to the ROAP Trigger Metering Report message. For example, the mobile terminal 100 may be in a low battery state or in a storage space shortage state.

In this case, the control unit 260 of the mobile terminal 100 sets the parameter “Extensions” to indicate that the mobile terminal 100 is not stable for transmitting the metering data. Accordingly, the mobile terminal 100 transmits a Metering Report Submit message with the parameter “Extensions” for indicating instability of the mobile terminal in step S503. In this manner, the mobile terminal 100 informs the RI 300 that the Metering Report Submit message is transmitted in an instable state, resulting in protection of metering data loss.

In response to the Metering Report Submit message, the RI 300 transmits a Metering Report Response message to the mobile terminal in step S405.

As described above, the mobile terminal transmits its status information in a form of the parameter “Extensions” of the Metering Report Submit message, whereby it is possible to protect the metering data loss caused by the unstable state.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

In the metering data report method for a DRM system according to the present invention, when storage space runs out, the mobile terminal transmits metering data for protecting useful data loss caused by overwriting, thereby improving stability of metering data report. Also, the metering data report method of the present invention enables the mobile terminal to provide the Right Issuer (RI) with information on metering data-reporting instability, thereby improving reliability of metering data report.

What is claimed is:

1. An information provision method for a mobile terminal, the method comprising:
determining whether an amount of metering data accumulated is greater than a preset threshold amount; and
transmitting, when the metering data amount is greater than the threshold amount, the metering data to a Right Issuer (RI).

2. The information provision method of claim 1, wherein the transmitting of the metering data comprises:
sending a trigger request message to the RI;
receiving a trigger message from the RI in response to the trigger request message;
sending a submit message containing the metering data to the RI upon receiving the trigger message; and
receiving a response message from the RI.

3. The information provision method of claim 2, wherein the trigger request message comprises a Metering Report Trigger Request message, the trigger message comprises a Rights Object Acquisition Protocol (ROAP) Trigger Metering Report message, the submit message comprises a Metering Report Submit message, and the response message comprises a Metering Report Response message.

4. The information provision method of claim 1, wherein the transmitting of the metering data comprises:
sending a submit message containing the metering data to the RI; and
receiving a response message from the RI in response to the submit message.

5. The information provision method of claim 4, wherein the submit message comprises a Metering Report Submit message containing a parameter for indicating that the metering data amount is greater than the threshold amount and the response message comprises a Metering Report Response message.

6. An information provision method for a mobile terminal, the method comprising:
receiving a trigger message requesting a metering report; and
transmitting, in response to the trigger message, a submit message containing a parameter for indicating whether the metering report is available to a Right Issuer (RI).

7. The information provision method of claim 6, wherein the transmitting of the submit message comprises setting, when the metering report is unavailable, the parameter to indicate unavailability of the metering report.

8. The information provision method of claim 7, wherein the unavailability comprises at least one of battery shortage and storage space shortage of the mobile terminal.

9. The information provision method of claim 7, wherein the submit message comprises a metering Report Submit message.

10. The information provision method of claim 6, further comprising receiving a response message in response to the submit message from the RI.

11. An information provision apparatus of a mobile terminal, the apparatus comprising:
a radio frequency unit for transmitting and receiving control messages; and
a control unit for determining whether to transmit a metering report according to a state of the mobile terminal and for transmitting, when the state of the mobile terminal is available for transmitting the metering report, the metering report to a Right Issuer (RI).

12. The information provision apparatus of claim 11, wherein the control unit transmits, when a metering data amount is greater than a threshold amount, the metering report by means of the radio frequency unit.

13. The information provision apparatus of claim 11, wherein the control unit controls the radio frequency unit to transmit, when a metering data amount is greater than a threshold amount, a trigger request message to the RI, and transmits, when receiving a trigger message in response to the trigger request message, the metering report to the RI.

14. The information provision apparatus of claim 11, wherein the control unit receives, after the transmitting of the metering report to the RI, a response message in response to the transmitting of the metering report from the RI.

15. The information provision apparatus of claim 13, wherein the trigger request message comprises a Metering Report Request message and the trigger message comprises a Rights Object Acquisition Protocol (ROAP) Trigger Metering Report message.

16. The information provision apparatus of claim 11, wherein the control unit transmits, when the state of the mobile terminal is not available for transmitting the metering report, a submit message containing a parameter indicating unavailability of the metering report.

17. The information provision apparatus of claim 16, wherein the unavailability comprises at least one of battery shortage and storage space shortage of the mobile terminal.

18. The information provision apparatus of claim 16, wherein the submit message comprises a Metering Report Submit message, and the unavailability represents at least one of battery shortage and storage space shortage of the mobile terminal.

19. The information provision apparatus of claim 11, further comprising a storage unit for storing an Operating System (OS) and metering data to be reported to the RI.
